(19) United States
(12) Patent Application Publication
(10) Pub. No.: US 2003/0035210 A1
(43) Pub. Date: Feb. 20, 2003

(54) Telescope

(76) Inventor: Timo Burzel, Lahnau (DE)

Correspondence Address: M. Robert Kestenbaum, 11011 Bermuda Dunes NE, Albuquerque, NM, 87111, US

(21) Appl. No.: 10/051,911

(22) Filed: Oct. 26, 2001

(30) Foreign Application Priority Data
Aug. 17, 2001 (DE) 101 40 504.9

(51) Int. Cl. G02B 23/00

(52) U.S. Cl. 359/428; 359/399; 359/424

(57) ABSTRACT

Telescope with a main tube in which a crosshair plate is movably arranged in an intermediate image plane. The crosshair plate can be moved relative to the main tube by means of a vertical drive and a horizontal drive. An index plate is associated with the crosshair plate of the telescope, is tiltably mounted in the main tube, and executes a tilting movement accompanying the movement of the crosshair plate in a horizontal direction.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to a telescope having a main tube, a crosshair plate movable arranged in an intermediate image plane, a vertical drive and a horizontal drive and the crosshair plate is movable relative to the main tube.

### TECHNICAL FIELD

A telescopic sight of the monocular and mono-objective type is known from DE 38 24 268 A1, and has a crosshair plate fixed in an intermediate image plane. This crosshair plate bears two scale divisions. The position of the crosshair plate can be altered in the vertical and horizontal directions relative to the outer housing of the telescopic sight by means of adjusting knobs, while looking through the telescopic sight. A pin for the telescopic sight is arranged such that it projects into the intermediate image plane in which the crosshair plate is arranged, or into a further intermediate image plane. This pin is held by a securing screw in an adjusting device which consists of two rotatable eccentric O-rings placed one inside the other. The O-rings can be locked, locking the pin. A further plate with an index marking can be provided instead of the pin.

The pin or the index mark serves as a pointer for a line figure with scale division situated on the crosshair plate, so that from the position of the pointer, the displacement of the inner tube with respect to the outer tube can be detected, based on the position of the pointer with respect to the line marking of the crosshair plate. In this arrangement, it is disadvantageous that the pin can be adjusted with only limited accuracy by means of the two O-rings. In addition, this construction is very expensive because of the numerous components.

A telescopic sight with crosshair plates, respectively located in one of the two intermediate image planes, is known from DE 31 45 035. These crosshair plates are adjustable with respect to the image seen through the telescopic sight. The second crosshair carrier is mounted so that one of plural surfaces carried by the crosshair carrier is presented, each crosshair plate surface having engraved indices which permit a determination of the target range and an estimation of the drop of the shot.

However, there is on this crosshair plate no indication from which the displacement of the knob for the range drive and/or of the knob for the lateral drive can be read off in the telescope.

If the crosshair plate is fixedly mounted in a reversing system, and if the reversing system is mounted on the eyepiece side in the main tube, the stationary index plate has to be mounted on the objective side in the main tube. Four distance and length measurements, to be made very exactly, are then necessary for the mounting of each telescopic sight, in order to produce a defined air gap between the target crosshair plate and the index crosshair plate. If these measurements are carried out in contact, contamination can occur of the crosshair plate and index plate, already cleaned for assembly.

In addition, it happens that the reversal system is rotated during an adjustment process around a point located in the neighborhood of the eyepiece plane. A reduction comes about of the distance between the target crosshair plate and index crosshair plate. Due to the rotary movement, this air gap does not remain parallel. This has to be taken into account in the definition of the crosshair plate distance, leading to an increase of the parallax between the target crosshair plate and the index crosshair plate.

Only an angular change in the horizontal plane of the reversal system is made in a lateral correction of the target line. Since the ballistic division is situated on the target line mark, and the index mark is however fixedly mounted in the main tube, a distance change takes place between the ballistic division and the index mark. This can lead to considerable inaccuracy of reading-out when the displacement paths are large.

### SUMMARY OF THE INVENTION

The invention has as its object to improve a telescope which has a crosshair plate and an index mark, such that the assembly cost, and hence the production costs, are reduced.

The invention had as a further object to provide a telescopic sight with crosshair plate and index plate, in which the parallax errors arising due to a change of the arrangement of the crosshair plate and index plate with respect to each other is reduced or prevented.

The invention had as its object to reduce the assembly cost.

The objects of the invention are attained by an index plate associated with the crosshair plate and tiltably mounted in the main tube. The index plate has a lateral guide.

By the measure of mounting the index plate tiltably in the main tube, it was possible to prevent, or at least considerably reduce, the parallax errors arising due to a changing distance between the crosshair plate and the index plate.

By the measure of providing a lateral guide, the index plate is entrained in the horizontal direction when there is a deflection of the crosshair plate. Due to this lateral guide, it is no longer necessary to adjust the index plate in the horizontal direction, and the production costs are thereby reduced.

Particularly by the measure of mounting the index plate both tiltably in the main tube and also providing it with a lateral guide, it was possible on the one hand to ensure that the distance between the crosshair plate and the index plate is always constant. On the other hand, the production costs are considerably reduced by these measures.

### BRIEF DESCRIPTION OF THE DRAWINGS

The invention is described in detail hereinafter using an embodiment example.

FIG. 1 shows a telescopic sight;

FIG. 2 shows a diagram of a portion of the telescopic sight shown in FIG. 1, in vertical section;

FIG. 3 shows a section along A-A through the telescopic sight shown in FIG. 2;

FIG. 4 shows a section along B-B through the telescopic sight shown in FIG. 2; and

FIG. 5 shows a horizontal section along C-C through the telescopic sight shown in FIG. 2.

### DETAILED DESCRIPTION OF THE INVENTION

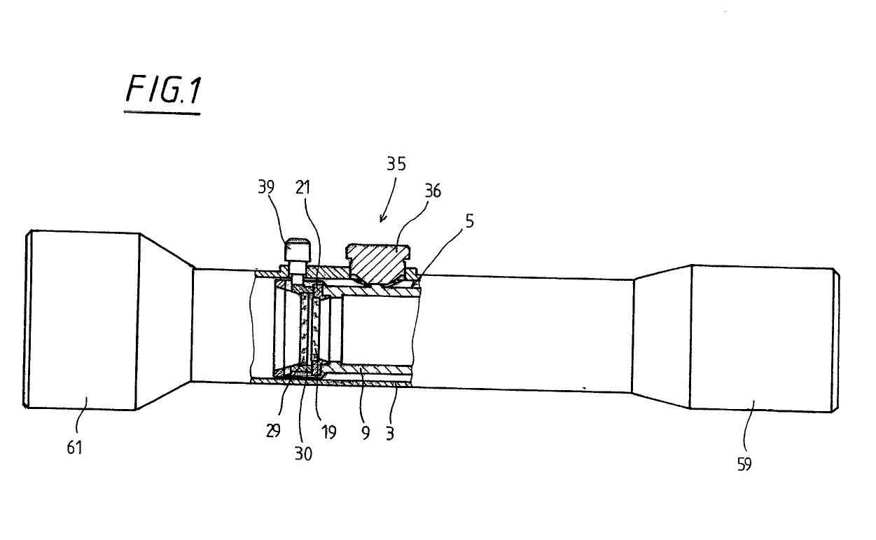

The principles of the construction of a telescope 1, here a telescopic sight, are first described using FIG. 1. The telescopic sight has an objective 61 and an eyepiece 59. The telescopic sight includes a main tube 3 in which a reversal system 5 is arranged. This reversal system 5 includes an inner tube 9 which is articulated in the main tube 3. An adjusting screw 36 of a vertical drive 35 acts on this inner tube 9 of the reversal system 5. A crosshair plate 19 is securely connected to the inner tube 9 of the reversal system 5 by means of a holder 21. An index plate 29 is arranged parallel to the crosshair plate 19, and is mounted in a holder 30. This holder 30 abuts on the holder 21 of the crosshair plate 19 on the side toward the crosshair plate 19. An adjusting element 39 acts on the holder 30 of the index plate 29, and by means of it the vertical position of the index plate 29 can be adjusted with respect to the main tube 3. The relative position of the index plate 29 to the crosshair plate 19 can thus also be altered by the actuation of this adjusting element 39.

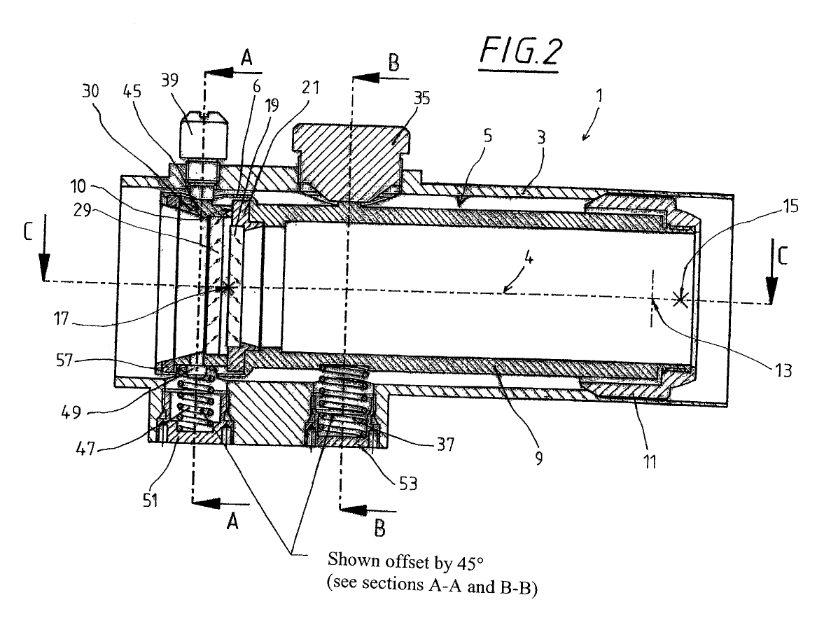

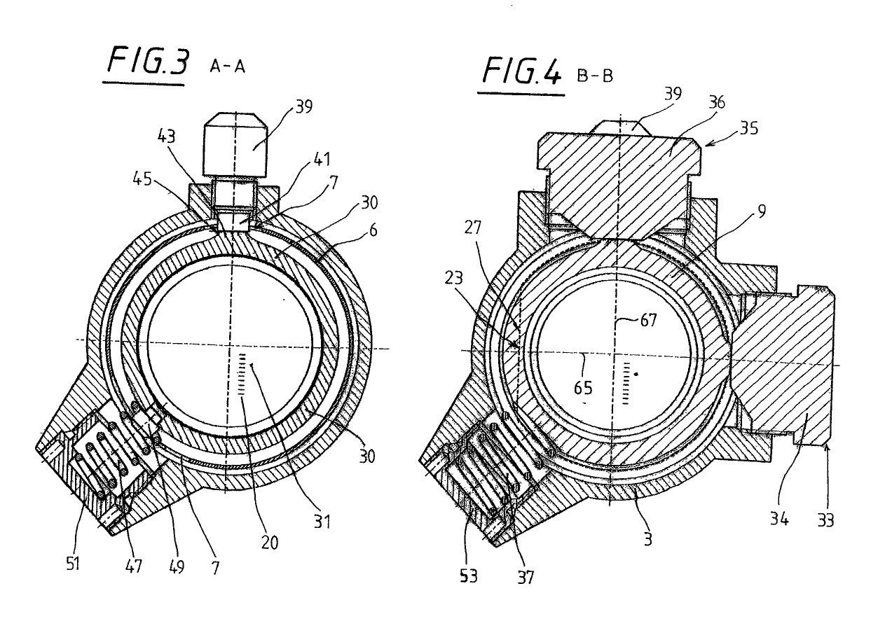

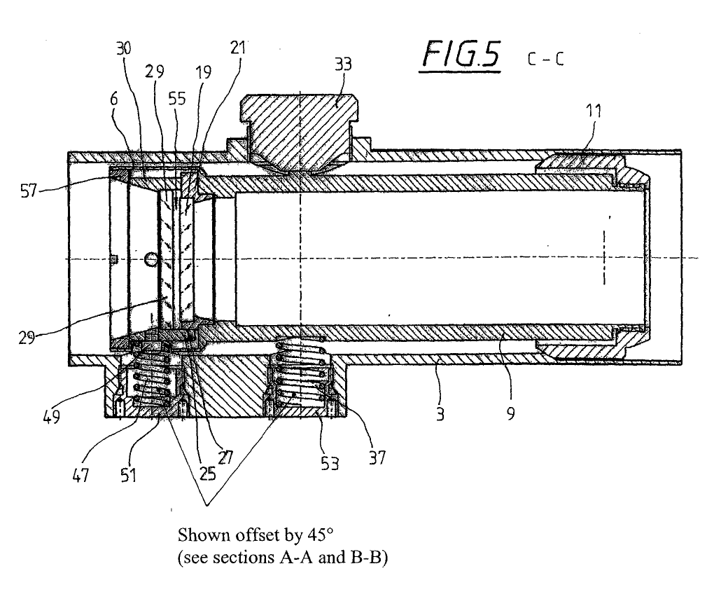

In FIGS. 2 and 5, springs 37 and 47 are offset by 45°, as seen in sections A-A and B-B shown in FIGS. 3 and 4 respectively.

A longitudinal section through the reversal system 5 is shown in FIG. 2. In this diagram, the distance between the crosshair plate 19 and the index plate 29 is shown enlarged. In reality, the distance is only a few hundredths of a millimeter.

The inner tube 9 is mounted, rotatably around a center of motion 13, in the main tube by means of a bearing 11 on the opposite side of the inner tube, i.e., on the end of the inner tube 9 toward the eyepiece 59. A horizontal drive with an adjusting screw 34, and a vertical drive 35 with an adjusting screw 36, are provided for the deflection of the crosshair plate 19, and thus of the inner tube 9 of the reversal system. The adjusting screws 34, 36 engage through the main tube 3 and act directly on the inner tube 9 of the reversal system 5. Moreover a spring 37 acts on the inner tube 9 of the reversal system 5 and ensures that the holder 9 of the reversal system always abuts on the adjusting screws 34, 36 of the vertical drive and horizontal drive. The horizontal drive 33 and the vertical drive 35 are formed by the adjusting screws 34, 36 together with the spring 37, as is apparent particularly well from FIG. 4. By the arrangement of the spring 37 at an angle of 45° with respect to the horizontal axis 65 and vertical axis 67, the spring 37 acts both as a return spring for the vertical drive 35 and also as a return spring for the horizontal drive 33. However, plural springs could be provided, arranged in a vertical plane symmetrically of this 45° axis.

In order to define a fixed engagement point of the spring 37 on the holder 9 of the reversal system, a recess in which the spring 37 engages is formed in the inner tube 9 of the reversal system. Other mechanisms, such as for example a pin which engages in the interior of such a coil spring 37, are also conceivable for delimiting the engagement point of the spring 37.

This spring 37 is prestressed to a pressure and is supported at the end opposed to the inner tube 9 against a cover 53 which is screwed securely to the main tube 3. It is thereby possible to mount the spring 37 after the reversal system has already been mounted, and thereby to bring the inner tube 9 of the reversal system 5 into a defined position. Because of the cover 53, this spring 37 can be changed without problems.

The inner tube 9 of the reversal system 5 has a sheathing 6 on the side toward the objective. In the embodiment example shown, the sheathing 6 is constituted integrally with the inner tube 9. It is however possible to provide a separate component which is securely connected to the inner tube with respect to the axial direction. This sheathing 6 is arranged coaxially of the holder 30 of the index plate 29. The sheathing 6 is provided on the side remote from the inner tube with a straining ring 57 which ensures that the holder 30 of the index plate 29 always abuts on the holder 21 of the crosshair plate 19. The sheathing 6 is made thin-walled. It is thus possible to provide a prestressing of the index plate 29 in the direction of the inner tube 9.

A desired free motion is set by means of this straining ring 57, so that the holder 30 follows the movement of the inner tube. In the embodiment example shown, a free motion in the range of 2 μm to 5 μm has been found to be suitable.

The sheathing 6, as is in particular clearly apparent from FIG. 3, has two openings 7 for the adjustment system of the index plate 29. The first opening 7 is provided for the adjusting element 39 which is connected to the main tube 3 and acts on a projection 43, formed on the holder 30, by means of an extension 41 which penetrates through the sheathing 6. This projection 43 is provided with a spherical surface by means of which the holder 30 is in contact with the extension 41 of the adjusting element 39. This spherical surface 45 could also be constituted on the side of the extension 41 facing toward the holder 30. It is ensured by this spherical surface 45 that on deflection of the inner tube 9 in a vertical direction the holder 30 executes a slight tilting movement, with a spring element 47 ensuring that the spherical surface 45 always abuts on the extension 41 of the adjusting element 39. By means of the tilting movement of the index plate 29, the air gap or interspace 55 between the crosshair plate 19 and index plate 29 remains constant. This spring element is arranged at an angle of 135° to the adjusting element 39, as is apparent from FIG. 3. This spring element is also supported against a closure element 51 which is securely connected to the main tube 3, so that this spring element can also be inserted into the main tube 3 after the assembly of the index plate. Changing, and prestressing under pressure, of the spring element 47 are easily possible by means of the closure element 51.

As will be apparent from FIGS. 4 and 5, the holder 30 is provided with an axial projection 25. This axial projection 25 abuts on a flat 23 formed on the lens mount 21. The spring element 47 acting on the holder 30 is arranged so that its direction of action includes an angle of 450 with the vertical axis 67 and the horizontal axis 65. It is thereby ensured by means of this spring element 47 that the projection 25 of the holder 30 always abuts on the flat 23. Lateral guiding of the index plate 29 is effected by the flat 23 and the projection 25 together with the spring element 47. An adjustment of the index plate in the horizontal direction is no longer necessary because of this lateral guiding. The index plate always follows the movement of the crosshair plate, due to this construction. The distance between the index plate 29 and the crosshair plate 19 is likewise shown enlarged in FIG. 5. In reality, this distance is only a few hundredths of a millimeter. The distance between the crosshair plate 19 and the index plate 29 is attained by means of the individual tolerances. An individual setting of this distance is thus no longer necessary. Also, the distance between the line marking 20 of the crosshair plate 19 and the index marking 31 which is provided on the index plate is kept within an acceptable tolerance by manufacturing tolerances alone, and makes possible an error-free reading out. In the embodiment example shown, tolerances of 0.02 μm to 0.1 μm are permissible.

If an illumination of the line marking 20 and/or of the index marking 31 is desired, this can take place by corresponding constitution of the holder 21 of the crosshair plate and of the holder 30 of the index plate, so that the crosshair plate 19 and the index plate 29 are exposed circumferentially to light.

The assembly of the telescopic sight 1 is described in detail hereinbelow. The lenses (not shown) of the reversal system and also the crosshair plate 19 are connected securely to the inner tube 9 of the reversal system 5 before the reversal system 5 is introduced into the main tube 3. The holder 30 with the index plate 29 is then introduced, from the axial direction toward the crosshair plate 19, into the sheathing 6 of the inner tube 9 of the reversal system 5, and is brought into abutment on the holder 21 of the crosshair plate 19. In order to fix the axial position of the holder 30, the straining ring 57 which abuts on the inner radius of the sheathing 6 is introduced into the sheathing 6. After mounting the reversal system 5 with crosshair plate 19 and index plate 29, the reversal system 5 with the inner tube 9 is introduced into the main tube 3 and fixed in the main tube 3 by means of the bearing 11. Subsequently, the adjusting screws 34, 36, 39 can be mounted to the main tube. The spring elements 37, 47 are then introduced; the fastening screw for the spring element 47 can already be mounted during the assembly of the reversal system 5. These spring elements 37, 47 are prestressed with the assembly of the closure elements 51, 53, which in the embodiment example shown are screwed in. The eyepiece can be mounted after assembly of the reversal system in the main tube. The objective 61 can be assembled either before or after the introduction of the reversal system 5 into the main tube 3. In the embodiment example shown, the index plate 29 and the crosshair plate 19 are arranged approximately in an intermediate image plane situated on the object side.

The manner of functioning of the telescopic sight is briefly described below. The index marks 31 carried by the index plate 29 can be set by means of the adjusting element 39 with respect to the main tube 3 so that, on looking through the telescopic sight 1, the index mark 31 assumes a predetermined position with respect to the line marking 20 carried by the crosshair plate 19. The reversal system and thus the crosshair plate 19 are thereby situated in a predetermined basic position. If the reversal system 5 is then deflected in the vertical direction by means of the adjusting screw 36, the amount of the deflection in the vertical direction can be read out directly at the changed position of the index mark 31 with respect to the line marking, on looking through the telescopic sight 1. Since the reversal system 5 is pivoted through an angle α around the center of motion 13 with a horizontally arranged axis of rotation, for a deflection of the reversal system 5 or of the inner tube 9 in the vertical direction, the index plate 29 also executes a corresponding tilting movement. Thereby, a change of the vertical position of the index mark with respect to the main tube 3 is also connected. This change of the vertical position of the index mark 31 is proportional to the cosine of the tilt angle α. This change of the vertical position of the index mark 31 in dependence on the deflection of the reversal system 5 or of the inner tube 9 from the basic position is compensated by a non equal distance between the single line marks 20 of the crosshair plate 19.

This arrangement can also be used in telescopic sights having the crosshair plate situated in the eyepiece plane.

Furthermore, this arrangement of the crosshair plate and index plate can also be used in binocular telescopes.

I claim:

1. A telescope, comprising:
a main tube comprising a crosshair plate movably arranged in an intermediate image plane,
a vertical drive and a horizontal drive by which the crosshair plate is movable relative to the main tube, and,
an index plate associated with the crosshair plate and tiltably mounted in the main tube.

2. The telescope according to claim 1, wherein the index plate is mounted such that the index plate is always aligned parallel to the crosshair plate.

3. The telescope according to claim 2, further comprising a reversal system comprising an inner tube having an abutment surface, and a holder carrying the index plate that abuts on the abutment surface.

4. The telescope according to claim 1, wherein the index plate comprises a lateral guide.

5. The telescope according to claim 1, further comprising an adjusting element,
wherein the index plate is movable relative to the main tube by means of the adjusting element.

6. A telescope, comprising:
a main tube comprising a crosshair plate movably arranged in an intermediate image plane,
a vertical drive and a horizontal drive by which the crosshair plate is movable relative to the main tube,
an index plate associated with the crosshair plate and tiltably mounted in the main tube, and
an adjusting element,
wherein the index plate is movable relative to the main tube by means of the adjusting element,
and wherein the adjusting element is in effective connection to the index plate by means of a spherical surface.

7. The telescope according to claim 1, further comprising
a holder for the crosshair plate, and
a holder for the index plate that abuts on one of the holder of the crosshair plate or on a component securely connected to the crosshair plate.

8. The telescope according claim 5, further comprising a spring element that cooperates with the adjusting element.

9. The telescope according claim 1, comprising a reversal system comprising a holder,
wherein the crosshair plate is securely connected to the holder of the reversal system.

10. The telescope according to claim 1, comprising
a holder for the crosshair plate,
a holder for the index plate, and
a lateral guide on the holder for the crosshair plate and on the holder for the index plate.

11. The telescope according to claim 1, wherein the crosshair plate and the index plate are spaced at a constant distance of less than 0.1 mm.

12. The telescope according to claim 11, wherein the constant distance is less than 0.05 mm.

13. The telescope according to claim 1, wherein the index plate comprises line markings and vertical distances between individual lines of the line markings are different in magnitude.

14. A process for producing a telescope according to claim 1, comprising the steps of pre-assembling the index plate and the crosshair plate outside the main tube.

15. The process according to claim 14, further comprising the step of introducing an inner tube in which the crosshair plate and the index plate are arranged into the main tube for final assembly.

16. The process according to claim 15, further comprising the step of mounting spring elements and springs after introducing the inner tube.

17. The telescope according to claim 6, further comprising
a holder for the crosshair plate, and
a holder for the index plate that abuts on one of the holder of the crosshair plate or on a component securely connected to the crosshair plate.

18. The telescope according claim 6, further comprising a spring element that cooperates with the adjusting element.

19. The telescope according claim 6, comprising a reversal system comprising a holder,
wherein the crosshair plate is securely connected to the holder of the reversal system.

20. The telescope according to claim 6, comprising
a holder for the crosshair plate,
a holder for the index plate, and
a lateral guide on the holder for the crosshair plate and on the holder for the index plate.

21. The telescope according to claim 6, wherein the crosshair plate and the index plate are spaced at a constant distance of less than 0.1 mm.

22. The telescope according to claim 6, wherein the index plate comprises line markings and vertical distances between individual lines of the line markings are different in magnitude.

23. A process for producing a telescope according to claim 6, comprising the steps of pre-assembling the index plate and the crosshair plate outside the main tube.
